(19) United States
(12) Patent Application Publication
(10) Pub. No.: US 2006/0019671 A1
(43) Pub. Date: Jan. 26, 2006

(54) QoS differentiation for WCDMA services mapped onto an E-DCH channel

(76) Inventors: Svetlana Chemiakina, Norresundby (DK); Preben Mogensen, Gistrup (DK)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 11/165,440

(22) Filed: Jun. 22, 2005

Related U.S. Application Data
(60) Provisional application No. 60/585,250, filed on Jul. 2, 2004.

(51) Int. Cl. H04Q 7/20

(52) U.S. Cl. 455/452.2

(57) ABSTRACT

A system has user equipment (1; 2) each having buffers (3, 4, 5, 6; 7, 8, 9, 10) for storing packets classified according to priority and ready for transmission over a radio interface to a network element (12). In such a system, user equipment sends capacity request signals (11; 13) indicative of the various priorities of the buffered packets on the radio interface to the network element. Rather than seeking a capacity allocation decision from a higher level in the core network, the network element itself makes the capacity allocation decision and provides a capacity allocation signal (14) to the user equipment. Packets that have thus been allocated capacity by the network element are then sent from the user equipment to the network element. Having the network element make the capacity allocation decisions itself is a more efficient system since the network element is in direct communication with the user equipment over the radio interface and the decision is made in an unmediated way.

### CROSS-REFERENCE TO RELATED APPLICATION

This application claims priority from U.S. provisional patent application No. 60/585,250 filed on Jul. 2, 2004.

### BACKGROUND OF THE INVENTION

In the known 3rd Generation Partnership Project (3GPP) for mobile communications, there is a Technical Specification in development relating to the Group Radio Access Network entitled “Feasibility Study for Enhanced Uplink for UTRA FDD, (Release 6).” The acronym UTRA stands for “UMTS Terrestrial Radio Access” and FDD stands for “Frequency Division Duplex.” “UMTS” means Universal Mobile Telecommunications System” and “Uplink” refers to the direction from the mobile User Equipment (UE) over a radio interface to the wired core network. Release 6 relates to an all IP (Internet Protocol) 3GPP solution (it should be realized that “all IP” can mean different things and one can make Release 6 without having “all” IP). The specification is in the form of a Technical Report (TR) with the given number 3GPP TR 25.896 V6.0.0 (2004-03). According to the statement of scope therein, the purpose of the TR is to help the Technical Specification Group (TSG) working in the Radio Access Network (RAN) Working Group 1 (WG1) to “define and describe the potential enhancements under consideration and compare the benefits of each enhancement with earlier releases for improving the performance of the dedicated transport channels in UTRA FDD uplink, along with the complexity evaluation of each technique. The scope is to either enhance uplink performance in general or to enhance the uplink performance for background, interactive and streaming based traffic”. The contemplated activity “involves the Radio Access work area of the 3GPP studies and has impacts both on the Mobile Equipment and Access Network of the 3GPP systems.” The intent is “to gather all information in order to compare the solutions and gains vs. complexity, and draw a conclusion on the way forward.”

The justification of the study is that “since the use of IP based services becomes more important there is an increasing demand to improve the coverage and throughput as well as reduce the delay of the uplink. Applications that could benefit from an enhanced uplink may include services like video-clips, multimedia, e-mail, telematics, gaming, video-streaming, etc. The study investigates enhancements that can be applied to UTRA in order to improve the performance on uplink dedicated transport channels.”

According further to the Introduction to TR 25.896, the study includes various topics related to enhanced uplink for UTRA FDD to enhance uplink performance in general or to enhance the uplink performance for background, interactive and streaming based traffic including the following shortened list:
Hybrid ARQ (Automatic Repeat reQuest) protocols,
Node B controlled scheduling,
Physical layer or higher layer signalling mechanisms to support the enhancements, and
Shorter frame size and improved QoS (Quality of Service).

The invention is applicable to Node B controlled scheduling of uplink packet services in WCDMA (Wideband Code Division Multiple Access) carried over the “Enhanced DCH,” a new, dedicated transport channel type. The E-DCH channel is discussed in the above-mentioned 3GPP TR 25.896 (E-DCH is a 3GPP Release 6 Work Item).

If the user equipment (UE) has several MAC-d flows and several logical channels active contemporaneously, some of them may require higher priority (e.g. streaming or signalling bearers), while others allow much higher flexibility in terms of delay requirement (e.g. background bearer). The available E-DCH resources over the air interface may be shared by several UEs in a cell. The distribution of the E-DCH air-interface resources among the UEs is decided at the Node B. This implies that if limited E-DCH resources are available, high priority data should be transmitted first (e.g. have higher scheduling priority). Currently the Node B has no information to permit it to prioritize among the capacity requests from different users.

The E-DCH channel is a new technology where this problem has not been solved yet. Previous releases of WCDMA (e.g. Release 99: 3GPP TS 25.922 v. 6.0.1) solve the QoS differentiation problem by mapping different services onto dedicated channels with different priority among them. The prioritization among radio bearers has been performed at the Radio Network Controller (RNC).

The above method is not optimal in case of E-DCH technology as the medium access control (Mac-e) will be located in the Node-B, and the available E-DCH resources must be shared with other users (in a shared channel fashion). In case of High Speed Data Packet Access (HSDPA) a similar problem is solved by using a Scheduling Priority Indicator (SPI) associated with different bearers from the RNC to the Node B (see 3GPP TS 25.433 v.6.1.0).

### DISCLOSURE OF INVENTION

However, in the case of E-DCH, the data to be transmitted is not located in the Node B but in the UE. Hence, it is presumed that the UEs need to make capacity requests to the Node B, either periodically or in an event based fashion. Such presumed capacity requests by the UEs should be prioritized according to the QoS demand.

According to a first aspect of the present invention, user equipment comprises a first mechanism for providing a capacity request signal to a network element communicating directly with said user equipment on a radio interface for capacity to send packets stored in one or more memory devices in said user equipment, said capacity request signal indicative of one or more priorities assigned to said one or more memory devices, a second mechanism, responsive to a capacity allocated signal from said network element communicating directly with said user equipment on said radio interface, said capacity allocated signal indicative of a capacity allocation made by said network element to a memory device for sending packets stored therein, for providing a retrieval signal, and a device, responsive to said retrieval signal for retrieving said packets stored in said memory device and for providing said packets, for transmission on said radio interface.

According to a second aspect of the present invention, a network element comprises a capacity allocation device, responsive to one or more capacity request signals on a radio interface from corresponding user equipment, for providing on said radio interface between said network element and said user equipment one or more capacity allocated signals indicative of capacity allocated to said packets on said radio interface according to said priorities, and a device, responsive to one or more signals from said corresponding user equipment, for receiving said packets allocated capacity on said radio interface according to said priorities.

According to a third aspect of the present invention, a system, comprises at least one user equipment each having at least one buffer for storing packets classified according to priority, and a network element for communicating directly to said at least one user equipment over a radio interface, responsive to capacity request signals indicative of various priorities of said packets on said radio interface between said user equipment and said network element, for providing a capacity allocation signal to said at least one user equipment for permitting packets selected by said network element according to said priorities to be sent from said at least one user equipment to said network element.

According to a fourth aspect of the present invention, a method comprises sending a capacity request signal over a radio interface between a user equipment and a network element to request a capacity allocation by said network element for packets ready for transmission over said radio interface and classified by said user equipment according to priority, and receiving a capacity allocation signal over said radio interface from said network element indicative of a capacity allocation decision made by said network element according to said priority indicated in said capacity request signal considering capacity available on an uplink of said radio interface.

According to a fifth aspect of the present invention, a computer program stored on a computer readable medium is for execution in user equipment, said program for enabling said user equipment to send a capacity request signal over a radio interface between said user equipment and a network element to request a capacity allocation by said network element for packets ready for transmission over said radio interface and classified according to priority, said program for enabling said user equipment to receive a capacity allocation signal over said radio interface from said network element indicative of a capacity allocation made by said network element according to said priority indicated in said capacity request signal considering capacity available.

According to a sixth aspect of the present invention, an integrated circuit is provided for use in a device of user equipment for enabling said user equipment to send a capacity request signal over a radio interface between said user equipment and a network element to request a capacity allocation by said network element for packets ready for transmission over said radio interface and classified according to priority, said integrated circuit for enabling said user equipment to receive a capacity allocation signal over said radio interface from said network element indicative of a capacity allocation made by said network element according to said priority indicated in said capacity request signal considering capacity available.

According to a seventh aspect of the present invention, a method comprises receiving at a network element a capacity request signal over a radio interface between a user equipment and said network element requesting a capacity allocation by said network element for packets ready for transmission over said radio interface and classified by said user equipment according to priority, and sending a capacity allocation signal over said radio interface from said network element to said user equipment indicative of a capacity allocation decision made by said network element according to said priority indicated in said capacity request signal, considering available capacity on said radio interface from said user equipment to said network element.

According to an eighth aspect of the present invention, a computer program stored on a computer readable medium is provided for execution in a network element in direct communication with user equipment over a radio interface, said program for enabling said network element to receive a capacity request signal over said radio interface from said user equipment requesting a capacity allocation for packets ready for transmission over said radio interface and classified by said user equipment according to priority, said program for enabling said network element to send a capacity allocation signal over said radio interface from said network element to said user equipment indicative of a capacity allocation decision made by said network element according to said priority indicated in said capacity request signal, considering available capacity of said radio interface from said user equipment to said network element.

According to a ninth aspect of the present invention, an integrated circuit is provided for use in a network element in direct communication with user equipment over a radio interface, said integrated circuit for enabling said network element to receive a capacity request signal over said radio interface from said user equipment requesting a capacity allocation for packets ready for transmission over said radio interface and classified by said user equipment according to priority, said integrated circuit for enabling said network element to send a capacity allocation signal over said radio interface from said network element to said user equipment indicative of a capacity allocation decision made by said network element according to said priority indicated in said capacity request signal, considering available capacity of said radio interface from said user equipment to said network element.

According to a tenth aspect of the present invention, a device comprises a first mechanism for sending a capacity request signal over a radio interface between a user equipment and a network element to request a capacity allocation by said network element for packets ready for transmission over said radio interface and classified by said user equipment according to priority, and a second mechanism for receiving a capacity allocation signal over said radio interface from said network element indicative of a capacity allocation decision made by said network element according to said priority indicated in said capacity request signal considering capacity available on an uplink of said radio interface.

According to an eleventh aspect of the present invention, a device comprises a mechanism for sending a capacity request signal over a radio interface between a user equipment and a network element to request a capacity allocation by said network element for packets ready for transmission over said radio interface and classified by said user equipment according to priority, and a mechanism for receiving a capacity allocation signal over said radio interface from said network element indicative of a capacity allocation decision made by said network element according to said priority indicated in said capacity request signal considering capacity available on an uplink of said radio interface.

According to a twelfth aspect of the present invention, a network element comprises a device for receiving a capacity request signal over a radio interface between a user equipment and a network element requesting a capacity allocation by said network element for packets ready for transmission over said radio interface and classified by said user equipment according to priority, and a capacity allocation device for sending a capacity allocation signal over said radio interface from said network element indicative of a capacity allocation decision made by said network element according to said priority indicated in said capacity request signal considering available capacity on said radio interface from said user equipment to said network element.

In the user equipment, every E-DCH related RLC buffer in the UE (a selected number, e.g., there may be up to eight) may be associated with a particular SPI. There could be, e.g., sixteen SPI values in a manner similar to the procedure used for High Speed Data Packet Access (HSDPA). E.g., the lowest value of an SPI (0) equates to the lowest priority, while the highest SPI value (15) means the highest priority. These SPIs may then be used by the UE when it makes a capacity request to the Node B. The Node B prioritizes the capacity requests by using the SPI associated with them.

The exact algorithm of how the Node B can utilize the SPI is implementation specific and is out of scope of this invention.

Advantages of the invention include improved QoS control for E-DCH.

These and other objects, features and advantages of the present invention will become more apparent in light of the detailed description of a best mode embodiment thereof, as illustrated in the accompanying drawing.

### BRIEF DESCRIPTION OF THE DRAWINGS

FIG. 1 shows a Node B in communication with plural UEs each having several RLC buffers associated with radio bearers with different priorities indicated by means of Scheduling Priority Indicators (SPIs), where, e.g., a higher SPI means a higher priority;

FIG. 2 is an illustration of elements of a UE of FIG. 1, according to the invention; and

FIG. 3 shows elements in the Node B of FIG. 1, according to the invention.

### BEST MODE FOR CARRYING OUT THE INVENTION

The SPI may be associated with the RLC buffers in the UE in different ways, for instance by means of Radio Resource Control (RRC) signalling from the Radio Network Controller (RNC).

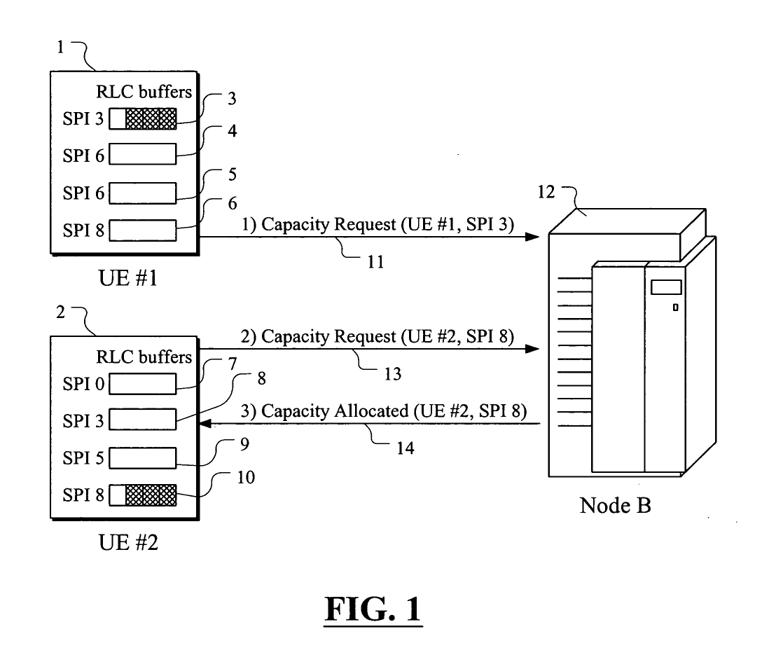

FIG. 1 presents the basic idea of the invention: each of a plurality of UEs 1, 2 have several RLC buffers associated with radio bearers with different priorities indicated by means of a Scheduling Priority Indicator (SPI) where, e.g., a higher SPI means a higher priority. UE 1 is shown with four buffers 3, 4, 5, 6 for storing packets with different SPIs 3, 6, 6, 8, respectively, while UE 2 is shown with four buffers 7, 8, 9, 10 for storing packets with different SPIs 0, 3, 5, 8, respectively. Of course it should be realized that the SPI associated with a given buffer can change according to the MAC-d flow or logical channel at any given moment. Only buffer 3 in UE 1 has any data packets at the moment ready for transmission. Similarly, only buffer 10 in UE 2 has any data packets at the moment ready for transmission. Capacity requests may be sent from the UEs to the Node B to try to get their “ready” packets permission to be sent. This may be done, for instance, by having each RLC buffer (SPI) be assigned by RRC signalling to a specific traffic volume threshold for triggering an event-based capacity request. E.g., when the traffic volume threshold is exceeded, the UE should make a capacity request to the Node B. As another example, a capacity request could be sent periodically. These examples are of course not exhaustive of the possibilities.

In the example illustrated in FIG. 1, the UE #1 has data ready for transmission in the RLC buffer 3 associated with SPI 3, while the UE #2 has data ready in the RLC buffer 10 associated with SPI 8. This means, e.g., that the UE #2 has data of higher priority compared to the data of the UE #1. Both UEs have made a capacity request as shown by a request signal on a line 11 from UE 1 to a Node B 12 and a radio uplink request signal on a line 13 from UE 2 to Node B 12. Each capacity request signal on the lines 11, 13 identify the respective UE and the SPI value associated with the buffer having the packets ready for transmission. In case there are insufficient E-DCH resources to allocate both capacity requests at the moment, the Node B will allocate the capacity for the request with the higher priority, e.g. as shown, with an allocation to the UE #2 only by means of a “capacity allocated” signal on a line 14 from Node B to UE 2.

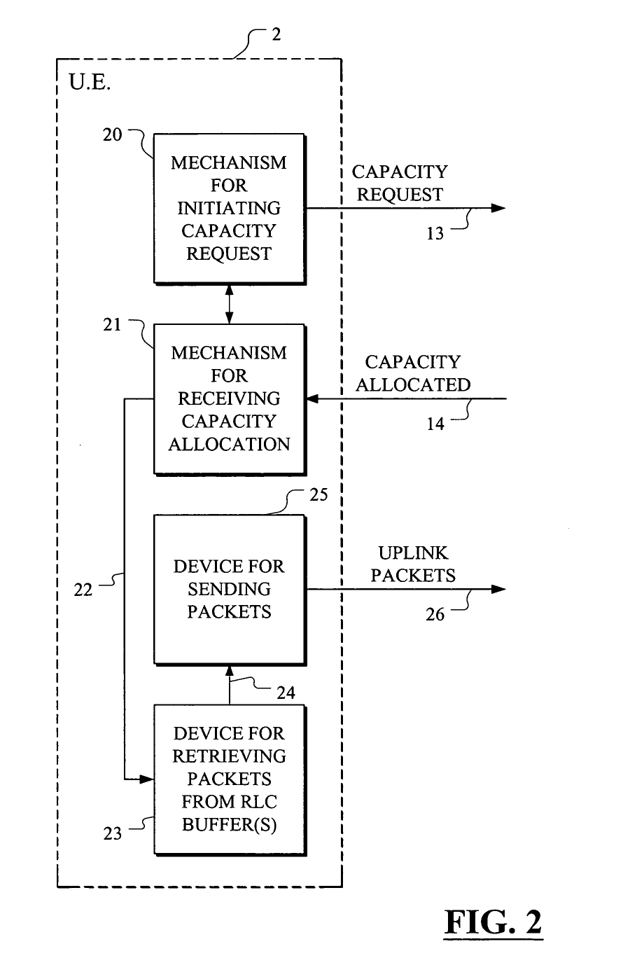

FIG. 2 shows one of the UEs of FIG. 1 in more detail. It includes a mechanism 20 for initiating a capacity request such as the request on the radio uplink signal on the line 13 of FIG. 1 based for instance on an event such as a comparison between traffic volume and a threshold, or based a periodic timing mechanism, or both. The capacity allocated signal on the radio downlink line 14 is received in UE 2 by a mechanism 21 for receiving incoming capacity allocation signals, conditioning them and interpreting the capacity allocated by the Node B. A signal on a line 22 may for instance then be provided from the mechanism 21 to a device 23 for retrieving packets from the RLC buffer 10 which has been allocated capacity by the Node B 12. The retrieved packets are then provided on a line 24 to a device 25 for sending the packets retrieved from RLC buffer 10 as a radio uplink signal on a line 26 from the UE 2 to the Node B 12.

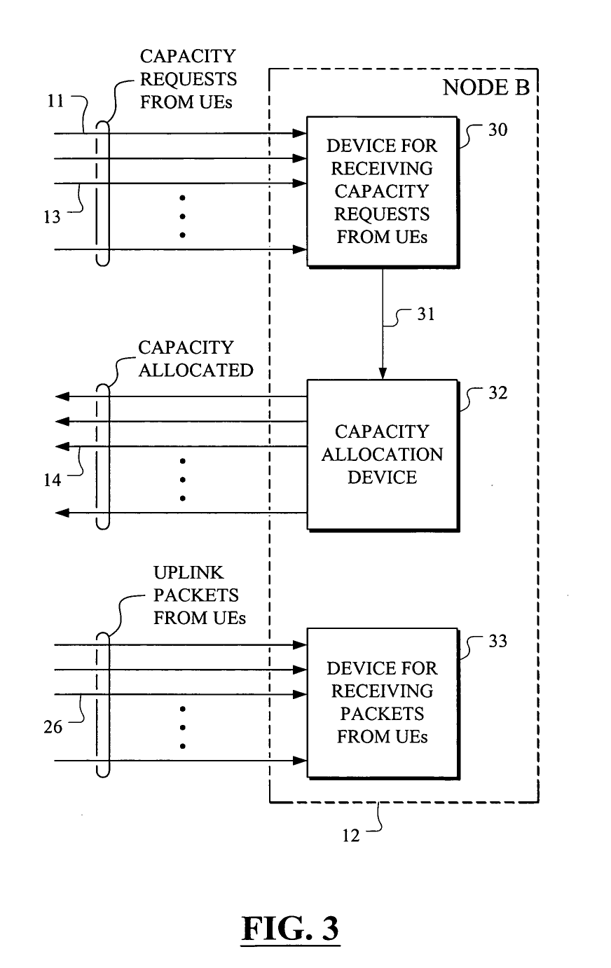

FIG. 3 shows details of the Node B 12 of FIG. 1. It should be realized that FIG. 1 only shows two UEs but many more can be served by the Node B 12 at the same time. Therefore, the two capacity request signals on the lines 11, 13 from FIG. 1 are shown in FIG. 3 among a larger plurality of capacity request signals from other UEs having RLC buffers with packets “ready” for transmission but having differing SPIs associated therewith. The plurality of capacity requests are received by a device 30 for receiving capacity requests from a plurality of UEs. Although not shown in FIG. 1, for purposes of simplicity, it should be realized that plural buffers within each such UE can also have packets “ready” for transmission and likewise competing for capacity allocation at the same time.

Once the capacity requests are received from the various UEs and RLC buffers by the Node B, the device 30 may process the requests in order to organize them for presentation in a selected format as processed capacity request signals indicative of the various requests on a line 31 to a capacity allocation device 32 where decisions concerning capacity allocations are made and signalled on a plurality of capacity allocation signals including the capacity allocated signal on the line 14 from the Node B 12 to the UE 2, indicating to UE 2 that the Node B has given permission for the contents of buffer 10 to be retrieved by the device 23 and sent by the device 25 on the line 26 from UE 2 to Node B 12. A device 33 within Node B 12 receives the uplink packets from the various UEs including the signal on the line 26 from UE 2 with uplink packets retrieved from buffer 10 with SPI 8. It should be noted that the network element itself, which would typically be the “Node B” in 3GPP systems, is the element that makes the capacity allocation decisions and not the Radio Network Controller. It therefore becomes a more efficient process because it is unmediated and uplink performance is enhanced. The decisions are made by the network element considering the capacity available on the radio interface between the user equipment and the network element in the direction from the user equipment to the network element according to the priorities indicated on the various capacity request signals received from the various user equipment and buffers thereof having packets ready for transmission.

It should be realized that the mechanisms and devices shown in FIGS. 2 and 3 can be carried out by software, firmware, or hardware, or a combination thereof. For instance, if there is a general purpose signal processor in the UE 2, each of the mechanisms 20, 21 and devices 23, 25 can be carried out in whole or in part by the general purpose signal processor following a sequence of coded instructions stored in a memory within the user equipment 2. The coded instructions would be coded according to a selected programming language which would be executed directly or interpreted by the signal processor. Likewise, the various functions described in conjunction with the description of the user equipment 2 as carried out by the particular mechanisms and devices shown in the user equipment can be embodied in an integrated circuit which has the necessary interconnected circuitry embodied therein. Or, as suggested, the functions carried out by the mechanisms and devices shown in FIG. 2 can be carried out by a combination of coded software instructions and one or more integrated circuits. What has just been described for the user equipment 2 of FIG. 2 is equally applicable to the network element 12 of FIG. 3 wherein a signal processor can be used to follow coded instructions stored in the network element or an integrated circuit can be used to carry out the same functions in hardware or a combination of both can be used. It also needs to be mentioned that these same functions can be carried out in either or both the user equipment or the network element using discrete components as well. It is known in the art to use discrete components in combination with software and integrated circuits as well. Therefore, it will be realized that the various functions shown in the functional blocks of FIGS. 2 and 3 can be carried out in whole or in part by software, integrated circuits or discrete components in any combination.

Although the invention has been shown and described with respect to a best mode embodiment thereof, it should be understood by those skilled in the art that the foregoing and various other changes, omissions and deletions in the form and detail thereof may be made therein without departing from the spirit and scope of this invention.

1. User equipment (2), comprising:
mechanism (20) for providing a capacity request signal (13) to a network element (12) communicating directly with said user equipment on a radio interface for capacity to send packets stored in one or more memory devices in said user equipment, said capacity request signal indicative of one or more priorities assigned to said one or more memory devices;
mechanism (21), responsive to a capacity allocated signal (14) from said network element communicating directly with said user equipment on said radio interface, said capacity allocated signal indicative of a capacity allocation made by said network element to a memory device (10) for sending packets stored therein, for providing a retrieval signal (22); and
device (23), responsive to said retrieval signal (22) for retrieving said packets stored in said memory device (10) and for providing said packets, for transmission on said radio interface.

2. Network element (12), comprising:
a capacity allocation device (32), responsive to one or more capacity request signals on a radio interface from corresponding user equipment (1, 2), for providing on said radio interface between said network element and said user equipment one or more capacity allocated signals (14) indicative of capacity allocated to said packets on said radio interface according to said priorities; and
a device (33), responsive to one or more signals (26) from said corresponding user equipment (1, 2), for receiving said packets allocated capacity on said radio interface according to said priorities.

3. System, comprising:
at least one user equipment (1, 2) each having at least one buffer (3, 4, 5, 6; 7, 8, 9, 10) for storing packets classified according to priority; and
a network element (12) for communicating directly to said at least one user equipment over a radio interface, responsive to capacity request signals (11, 13) indicative of various priorities of said packets on said radio interface between said user equipment and said network element, for providing a capacity allocation signal (14) to said at least one user equipment for permitting packets selected by said network element according to said priorities to be sent from said at least one user equipment to said network element.

4. Method, comprising:
sending a capacity request signal over a radio interface between a user equipment and a network element to request a capacity allocation by said network element for packets ready for transmission over said radio interface and classified by said user equipment according to priority, and
receiving a capacity allocation signal over said radio interface from said network element indicative of a capacity allocation decision made by said network element according to said priority indicated in said capacity request signal considering capacity available on an uplink of said radio interface.

5. A computer program stored on a computer readable medium for execution in a device of user equipment, said program for enabling said user equipment to send a capacity request signal over a radio interface between said user equipment and a network element to request a capacity allocation by said network element for packets ready for transmission over said radio interface and classified according to priority, said program for enabling said user equipment to receive a capacity allocation signal over said radio interface from said network element indicative of a capacity allocation made by said network element according to said priority indicated in said capacity request signal considering capacity available.

6. Integrated circuit for use in a device of user equipment for enabling said user equipment to send a capacity request signal over a radio interface between said user equipment and a network element to request a capacity allocation by said network element for packets ready for transmission over said radio interface and classified according to priority, said integrated circuit for enabling said user equipment to receive a capacity allocation signal over said radio interface from said network element indicative of a capacity allocation made by said network element according to said priority indicated in said capacity request signal considering capacity available.

7. Method, comprising:
receiving a capacity request signal over a radio interface between a user equipment and a network element requesting a capacity allocation by said network element for packets ready for transmission over said radio interface and classified by said user equipment according to priority, and
sending a capacity allocation signal over said radio interface from said network element indicative of a capacity allocation decision made by said network element according to said priority indicated in said capacity request signal, considering available capacity on said radio interface from said user equipment to said network element.

8. A computer program stored on a computer readable medium for execution in a network element in direct communication with user equipment over a radio interface, said program for enabling said network element to receive a capacity request signal over said radio interface from said user equipment requesting a capacity allocation for packets ready for transmission over said radio interface and classified by said user equipment according to priority, said program for enabling said network element to send a capacity allocation signal over said radio interface from said network element to said user equipment indicative of a capacity allocation decision made by said network element according to said priority indicated in said capacity request signal, considering available capacity of said radio interface from said user equipment to said network element.

9. Integrated circuit for use in a network element in direct communication with user equipment over a radio interface, said integrated circuit for enabling said network element to receive a capacity request signal over said radio interface from said user equipment requesting a capacity allocation for packets ready for transmission over said radio interface and classified by said user equipment according to priority, said integrated circuit for enabling said network element to send a capacity allocation signal over said radio interface from said network element to said user equipment indicative of a capacity allocation decision made by said network element according to said priority indicated in said capacity request signal, considering available capacity of said radio interface from said user equipment to said network element.

10. Device, comprising:
mechanism (20) for sending a capacity request signal over a radio interface between a user equipment and a network element to request a capacity allocation by said network element for packets ready for transmission over said radio interface and classified by said user equipment according to priority, and
mechanism (21) for receiving a capacity allocation signal over said radio interface from said network element indicative of a capacity allocation decision made by said network element according to said priority indicated in said capacity request signal considering capacity available on an uplink of said radio interface.

11. Network element, comprising:
device (30) for receiving a capacity request signal over a radio interface between a user equipment and a network element requesting a capacity allocation by said network element for packets ready for transmission over said radio interface and classified by said user equipment according to priority; and
capacity allocation device (32) for sending a capacity allocation signal over said radio interface from said network element indicative of a capacity allocation decision made by said network element according to said priority indicated in said capacity request signal, considering available capacity on said radio interface from said user equipment to said network element.
